(19) United States
(12) Patent Application Publication
(10) Pub. No.: US 2014/0173000 A1
(43) Pub. Date: Jun. 19, 2014

(54) SYSTEM AND METHOD FOR HANDLING MESSAGE DELIVERY

(71) Applicant: NVIDIA CORPORATION, Santa Clara, CA (US)

(72) Inventor: Kevin Brown, Santa Clara, CA (US)

(73) Assignee: NVIDIA CORPORATION, Santa Clara, CA (US)

(21) Appl. No.: 13/719,873

(22) Filed: Dec. 19, 2012

(51) Int. Cl. H04L 12/58

(52) U.S. Cl. CPC H04L 51/24
USPC 709/206

(57) ABSTRACT

A message handler, a method of handling message delivery and a message delivery device. In one embodiment, the message handler includes: (1) a network interface operable to detect a receipt of an inbound message via a communication network and (2) an alert manager associated with the network interface and operable to employ calendar data of a user to make a determination of whether a message delivery device associated with the user should generate an alert to the user regarding the receipt.

### TECHNICAL FIELD

This application is directed, in general, to communication networks and, more specifically, to a system and method for handling the delivery of messages received via a communication network.

### BACKGROUND

It seems that not so long ago, “getting away from it all” was not too difficult. One could find solace in one's car or otherwise away from one's residence or workplace. Achieving quietude at home or work was not terribly difficult either, provided the telephone was unplugged or ignored. Accordingly, the social contract of that day included an implicit understanding that people could often be utterly unavailable; successfully reaching someone on the first try was more an exception than the rule.

For better or worse, unreachability has essentially disappeared over the last few decades. Several factors have played a role in its near-total demise. First, portable communication devices, such as cellphones, personal digital assistants (PDAs) and smartphones have come into near universal use. These devices know few geographic bounds and are sized and suited to remain at their users' sides all day and all night. Second, an array of new communication modes has appeared. No longer is distant communication limited to telegrams, telephone calls and facsimile transmissions (faxes). Now, electronic mail (email), text messages (texts), Facebook® status updates, Twitter® Tweets® and streaming items such as news (including weather and sports) updates have the potential to bombard users with information, valuable or otherwise. Third, the social contract has been overhauled to provide that people are not only more available, but that they can reasonably be expected to be available instantaneously, almost irrespective of the hour.

Peace and privacy have become precious commodities as a consequence. A brave new world has arisen in which one can expect to encounter incoming messages, such as telephone calls, emails, texts, updates, Tweets® and alerts at all times, propitious or otherwise.

All of the above likely implies that being in constant communication is uniformly bad. This is certainly not the case. Constant connectivity has greatly increased the density of interaction among people and substantially increased the speed at which information and reactions are traded and disseminated. Social and business interaction is far more intense and immediate. While relationships may be more superficial, they tend to be more numerous and persistent. The world is generally faster and more productive than ever.

### SUMMARY

One aspect provides a message handler. In one embodiment, the message handler includes: (1) a network interface operable to detect a receipt of an inbound message via a communication network and (2) an alert manager associated with the network interface and operable to employ calendar data of a user to make a determination of whether a message delivery device associated with the user should generate an alert to the user regarding the receipt.

Another aspect provides a method of handling message delivery. In one embodiment, the method includes: (1) receiving an inbound message from a source via a communication network, (2) retrieving calendar data of a user, (3) making a determination of whether a message delivery device associated with the user should generate an alert to the user regarding the receipt and (4) queuing the alert for delivery to the message delivery device based on the determination.

Yet another aspect provides a message delivery device. In one embodiment, the message delivery device includes: (1) a display operable to provide an alert, (2) a processor coupled to the display and operable to execute software instructions and (3) a memory coupled to the processor and operable to store a calendar database and software instructions operable to employ calendar data from the calendar database to make a determination of whether the message delivery device should generate an alert regarding a receipt of an inbound message via a communication network.

### BRIEF DESCRIPTION

Reference is now made to the following descriptions taken in conjunction with the accompanying drawings, in which:

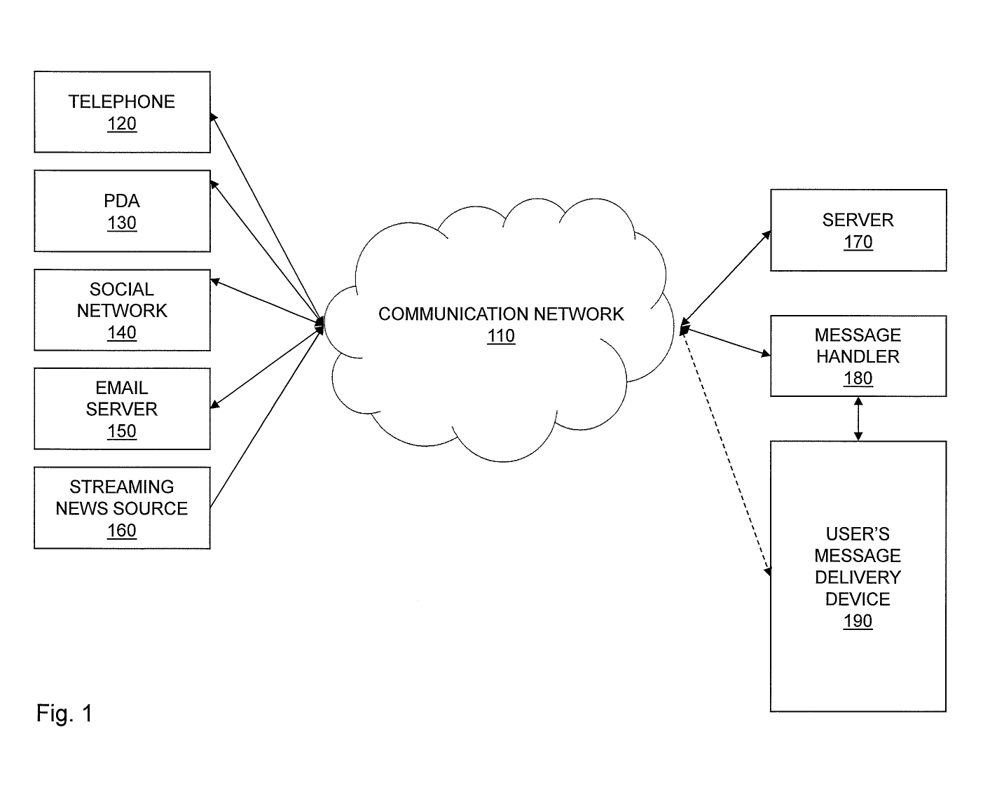

FIG. 1 is a block diagram of one embodiment of a communication network providing an environment in which a system for handling message delivery may be incorporated or with which a method of handling messages may be carried out;

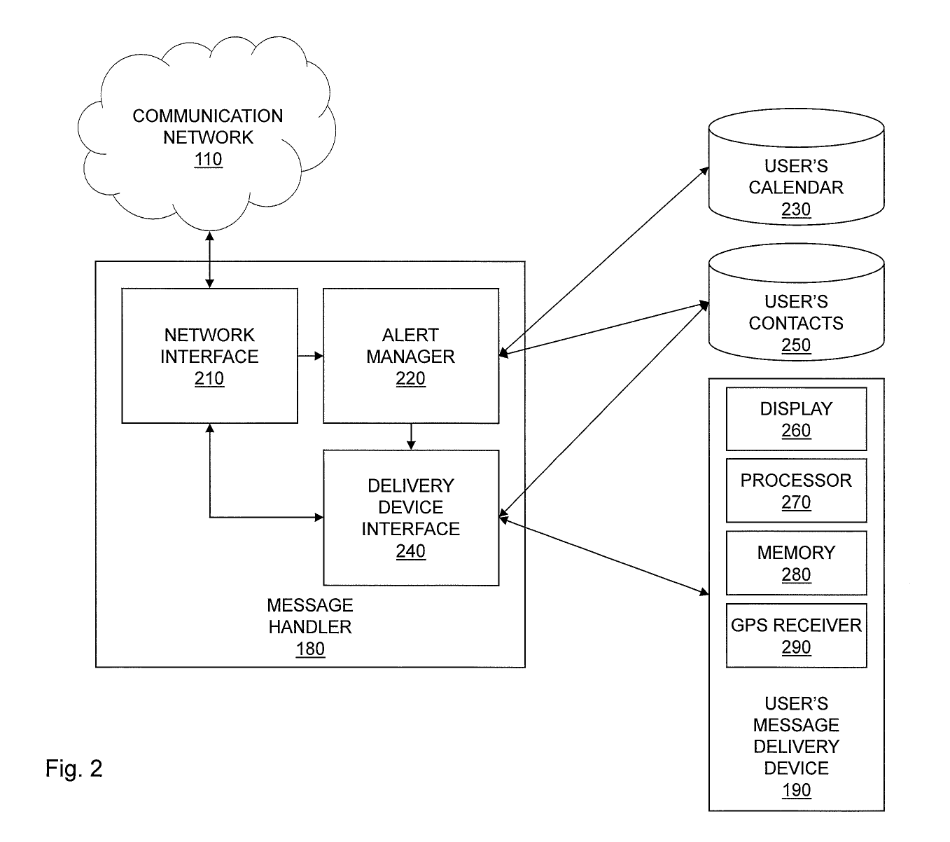

FIG. 2 is a block diagram of one embodiment of a message handler; and

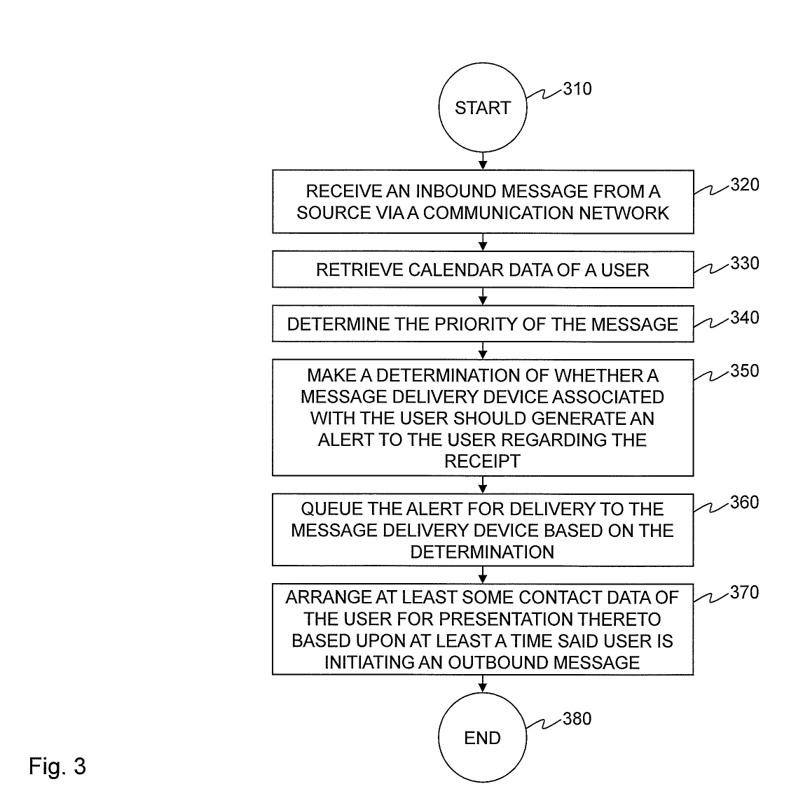

FIG. 3 is a flow diagram of one embodiment of a method of handling message delivery.

### DETAILED DESCRIPTION

As stated above, unreachability has essentially disappeared over the last few decades. A user can expect his or her message delivery device (e.g., smartphone, PDA or other information appliance or computer) to sound continual alerts of nascent, incoming messages. However, as stated above, alerts may sound at impropitious times, such as during an important appointment. Other alerts may be unimportant and therefore inappropriate while eating, driving or sleeping.

Conventional mechanisms exist by which a user can disable messages during defined windows of time, such as between 10 p.m. and 9 a.m. However, these hard-and-fast windows are inflexible and somewhat laborious to change. For example, a nighttime window would not deflect a casual telephone call received during a weekly meeting with the president of one's employer or an inconsequential Tweet® received while unwinding at dinnertime. Of course, one could constantly define new windows of time, but this would be an overwhelming irritant and unacceptable to all but the most assiduous users.

It is realized herein that people's schedules tend to change from day to day and that a correspondingly flexible, novel mechanism is needed to allow communication be controlled more flexibly. It is further realized herein that modern message delivery devices already contain information that such a novel mechanism may employ to advantage. It is still further recognized that the inbound messages themselves may be parsed in a more sophisticated manner to enhance communication control. It is yet further realized that the information already contained in modern message delivery devices may be employed more intelligently to provide greater context and assistance to a user in the creation of outbound messages.

Accordingly, introduced herein are various embodiments of a message handling system and method designed in general to increase the flexibility with which inbound, and perhaps outbound, messages are handled. The system takes the form of a message handler. In some embodiments, the manner in which inbound messages are handled is determined as a natural result of one's calendar, such that adding an appointment automatically changes how messages are handled during that appointment. Thus, in some embodiments, message handling can become automatic, requiring no effort on the part of the user over and above maintaining his or her calendar of appointments.

The inbound message may be: an inbound telephone call, an inbound text message, an inbound communication from a social network, an inbound email message or an inbound news item. These and other types of conventional or later-developed messages are equivalent in the sense that a single system or method can handle them. In certain embodiments, the calendar data includes an existence of an appointment of the user, a priority of an appointment of the user or at least one contact rule associated with an appointment of the user. These types of calendar data are equivalent in the sense that they can be drawn from a calendar database and provide information that can be used to handle messages. In one embodiment, the priority of the appointment is determined based on the participants thereof. Certain of the embodiments are configured to employ the user's calendar database to make a determination of whether the message delivery device should generate an alert regarding the receipt of an inbound message (e.g., by employing the calendar database to determine that the user is currently engaged in an appointment or by reading an appointment priority from the calendar database).

Other embodiments are configured to employ the user's contacts database to determine a priority of the inbound message (e.g., by employing the contacts database to determine a name or address of the party associated with the inbound message). Still other embodiments are configured to determine the priority of the inbound message based on the name of the party associated with the inbound message, contact information of the party associated with the inbound message, the frequency of messages received from the party associated with the inbound message, the frequency of messages sent by the user to a party associated with the inbound message, the type of the inbound message (e.g., telephone call, email, status update, Tweet® or news item or a source of the inbound message (e.g., the party making the telephone call, Facebook®, Twitter®, the particular email account, CNN®). These bases are equivalent in the sense that they may be employed to determine priority. Still further embodiments are configured to determine the priority of the inbound message based upon priority data (e.g., as indicated by a number, say from zero to nine, provided by the party associated with the inbound message). Other embodiments may include other overt or implicit indicia of priority with a message. For example, the user's entire sphere of communication may be employed to determine relative importance. Further, the message handling system and method may learn the user's patterns over time and derive relative priorities from them. In some embodiments, the user may train the message handling system and method over time (e.g., if a relative priority is incorrectly determined, the user may correct it and thereby bias future determinations). Those skilled in the pertinent art should understand, too, that priority often has context. For example, an inbound message from a work colleague may have a higher priority during a work-related appointment, but an inbound message from the same colleague may have a lower priority during a personal appointment; inbound messages from a family member are likely to experience an inverse priority.

In some embodiments, the alert takes the form of all or part of the inbound message itself. In other embodiments, the message handling system and method are operable to transmit a command to the message delivery device. Thus, the message delivery device may display some or all of the inbound message on its display or cause a lamp, a vibrator or a speaker to be activated to provide a visual, haptic or audible alert to the user.

In certain embodiments, the message handler is embodied in a sequence of software instructions executable in a general-purpose computer. Therefore, in some embodiments, the sequence of software instructions may be executed in the message delivery device itself (perhaps taking the form of an “app”) or in a computer (e.g., a server) associated with the communication network (perhaps taking the form of a free, advertising-supported or fee-based service that may be provided to multiple users).

In some embodiments, the message handler is further operable to employ the location of the message delivery device to make the determination. Thus, a message delivery device that has triangulation or Global Positioning Satellite (GPS) capability may be employed to advantage. In other embodiments, the message handler provides a mechanism by which the user can supply a predetermined outbound message responding to the inbound message.

Still other embodiments assist a user with outbound messages. Accordingly, those embodiments are configured to create an arrangement of at least some contact data of the user for presentation thereto, the arrangement based upon at least a time of the initiating.

Some specific examples of the above-listed embodiments will now be described in detail. FIG. 1 is a block diagram of one embodiment of a communication network 110 that provides an environment in which a method handler may be incorporated or with which a method of handling messages may be carried out. A plurality of potential messages sources are shown as being associated with the communication network 110, including a telephone 120 (e.g., a plain old telephone set, or POTS telephone, coupled via a public switched telephone network, or PSTN, not shown, or a cellphone or smartphone), a PDA 130 (e.g., a Blackberry®, Alpha Smart®, LOOX®, iPAQ® or Palm PDA), a social network 140 (e.g., Facebook®, Twitter®, Google Plus+®, Linkedln®, MySpace®, LiveJournal®, Tagged®, Orkut®, Pinterest®, CafeMom®, Meetup®, or MyLife®), an email server 150 (e.g., a POPS or Microsoft® Exchange® server), and a streaming news source 160 (e.g., CNN, ESPN, FoxNews, CNBC, Bloomberg, Associated Press or the BBC).

A server 170 is also shown as being associated with the communication network 110. In one embodiment, the server 170 provides an environment for execution of software instructions constituting an embodiment of the message handler or method disclosed herein.

A message handler 180 is further shown as being associated with the communication network 110. Associated with the message handler (and likely associated with the communication network 110 as well) is a message delivery device 190 which, for the purposes of this description, is associated with a user (not shown).

In general, the message handler 180 is operable to employ calendar data from a calendar database associated with the message delivery device 190 to make a determination of whether the message delivery device 190 should generate an alert regarding a receipt of an inbound message via the communication network 110. Based on the determination, the message handler 180 may be further operable to cause the alert to be transmitted to the message delivery device 190 based on the determination. In the illustrated embodiment, the message handler 180 causes the message delivery device 190 to generate the alert only if the message handler 180 determines that the message delivery device 190 should generate the alert.

FIG. 2 is a block diagram of one embodiment of the message handler 180 of FIG. 1. In the example embodiment of FIG. 2, the message delivery device 190 with which the message handler 180 cooperates includes a display 260, a processor 270, a memory 280 and a Global Positioning Satellite (GPS) receiver 290. PDAs and smartphones, among other conventional message delivery devices, typically have the display 260, the processor 270 and the memory 280. Some PDAs and smartphones have the GPS receiver 290 or a capability to locate themselves, perhaps by known radio triangulation techniques.

The message handler 180 includes a network interface 210. The network interface 210 is operable to detect a receipt of an inbound message via the communication network 210. The message handler 180 further includes an alert manager 220. The alert manager 220 is associated with the network interface 210 and operable to employ calendar data of a user associated with the message delivery device 190 to make a determination of whether the message delivery device 190 should generate an alert to the user regarding the receipt. The user's calendar data may be contained in a calendar database 230. In one embodiment, the calendar database 230 is stored in the memory 280. In alternative embodiments, the calendar database 230 is stored outside of the message delivery device 190 (e.g., in the “cloud” of the communication network 110).

The illustrated embodiment of the message handler 180 still further includes a delivery device interface 240. The delivery device interface 240 is associated with the alert manager 220 and operable to queue the alert for transmission to the message delivery device 190. In one embodiment, the alert is at least a portion of the inbound message, which may be displayed on the display 260, for example. In another embodiment, the alert is a command to the message delivery device 190, which may cause the message delivery device 190 to place an indication that a new message has been received on the display 260 or perhaps light a lamp, make a sound or vibrate to alert the user.

The alert manager 220 is configured to withhold the alert if the determination is such that the alert should not be generated. Accordingly, in the illustrated embodiment, the alert manager 220 is operable to schedule a future delivery of the alert. In one embodiment, the alert manager 220 schedules the future delivery when the priority of the inbound message begins to exceed that of any appointment in which the user is engaged.

In the illustrated embodiment, the delivery device interface 240 is further capable of providing assistance to the user regarding an outbound message that the user wants to send. Accordingly, the illustrated embodiment of the delivery device interface 240 is further operable to create an arrangement of at least some contact data of the user for presentation to the user. In the context of FIG. 2, the delivery device interface 240 interacts with a contacts database 250 associated with the user. In one embodiment, the contacts database 250 is stored in the memory 280. In alternative embodiments, the contacts database 250 is stored outside of the message delivery device 190 (e.g., in the “cloud” of the communication network 110). In the illustrated embodiment, the delivery device interface 240 is operable to make the arrangement based upon at least a time the user is initiating an outbound message.

Having described various embodiments of the message handler, some examples of its operation will now be set forth, with the understanding that these are merely examples and not indicative of the full scope of the invention.

In a first example, an inbound message taking the form of a telephone call is received via the communication network 110. In response, the network interface 210 detects receipt of the inbound message via the communication network 210. The alert manager 220 makes a determination of whether the message delivery device 190 should generate an alert to the user regarding the receipt by querying the calendar database 230 to see if the user is currently engaged in an appointment. If the user is currently engaged in an appointment, the alert manager 220 withholds the generation of the alert. Specifically, the alert manager 220 either causes the message delivery device 190 to vibrate instead of ring, or go to voicemail, or instruct the calling party to call back later, perhaps in accordance with the manner in which the user has configured the message delivery device 190 to operate during an appointment. If the user is not currently engaged in an appointment, the alert manager 220 causes the message delivery device 190 to generate the alert.

In a second example, an inbound message taking the form of a text message is received. In response, the network interface 210 operates as described above. The alert manager 220 makes a determination of whether the message delivery device 190 should generate an alert to the user regarding the receipt by querying the calendar database 230 to see if the user is currently engaged in an appointment. However, in this example, the user has also assigned the appointment a priority. The alert manager 220 determines the priority of the inbound message to be rather high, because it is a text message. The alert manager 220 compares the priority of the inbound message to the priority of the appointment. If the priority of the inbound message is lower than the priority of the appointment, the alert manager 220 withholds the generation of the alert. If the priority of the inbound message at least equals the priority of the appointment, the alert manager 220 causes the message delivery device 190 to generate the alert.

In a third example, an inbound message taking the form of a text message is received. The alert manager 220 queries the contacts database 250 to see if the user has assigned the party associated with the message a priority. The alert manager 220 determines the priority of the inbound message to be the highest, because, the user has assigned the party the highest priority. While the alert manager 220 compares the priority of the inbound message to the priority of the appointment, the priority of the inbound message is assumed at least to equal the priority of the appointment, the alert manager 220 causes the message delivery device 190 to generate the alert.

In a fourth example, an inbound message taking the form of an email is received. The inbound message contains overt priority data in its subject line, namely a number from zero to nine. The alert manager 220 compares the priority of the inbound message to the priority of the appointment. If the priority of the inbound message is lower than the priority of the appointment, the alert manager 220 withholds the generation of the alert. If the priority of the inbound message at least equals the priority of the appointment, the alert manager 220 causes the message delivery device 190 to generate the alert.

In a fifth example, an inbound message taking the form of a Pinterest® post is received. The alert manager 220 examines the inbound message for keywords to determine the priority of the inbound message. If the priority of the inbound message is lower than the priority of the appointment, the alert manager 220 withholds the generation of the alert. If the priority of the inbound message at least equals the priority of the appointment, the alert manager 220 causes the message delivery device 190 to generate the alert.

In a sixth example, an inbound message taking the form of a telephone call is received. The alert manager 220 determines that the party associated with the inbound message has originated ten such inbound messages in the last hour. This example also assumes that the user has established a contact rule treating an inbound message originated by a party exhibiting a high inbound message frequency as having a high priority. Nonetheless, if the priority of the inbound message is at least equals the priority of the appointment, the alert manager 220 withholds the generation of the alert. If the priority of the inbound message is higher than the priority of the appointment, the alert manager 220 causes the message delivery device 190 to generate the alert.

In a seventh example, an inbound message taking the form of an email is received. The alert manager 220 determines that the inbound message is in response to an outbound message recently generated by the user or is from a party the user frequently contacts and therefore has a high priority. The alert manager 220 withholds the generation of the alert or causes the message delivery device 190 to generate the alert as appropriate.

In an eighth example, an inbound message taking the form of a news item is received. The alert manager 220 determines that the inbound message contains keywords that relates to the user's business, and that the user is at a dinner appointment. Accordingly, the alert manager 220 withholds the generation of the alert.

In a ninth example, an inbound message taking the form of a Facebook® post is received. The alert manager 220 queries the contacts database 250 to determine the priority of the party associated with the inbound message. Having determined that the user has not assigned a priority to the party, the alert manager 220 assigns a default low priority to the inbound message, because it is only a Facebook® post.

In a tenth example, an inbound message taking the form of a text message is received at 3 AM on a Sunday morning. The alert manager 220 determines the priority of the inbound message. The alert manager 220 queries the calendar database 230 to determine whether the user has an appointment. However, while the alert manager 220 determines that the user does not have an explicit appointment, the alert manager 220 assumes the user to be asleep and assumes a relatively high-priority appointment. The alert manager 220 withholds the generation of the alert or causes the message delivery device 190 to generate the alert as appropriate. It should be stated that the assumption that the user is asleep may be based on an explicit rule set by the user or inferred from a lack of outbound message origination or other activity (e.g., Internet interaction) by the user.

In an eleventh example, an inbound message taking the form of a telephone call is received. The alert manager 220 determines the priority of the inbound message. The alert manager 220 queries the GPS receiver 290 to determine where the message delivery device 190 is located. The alert manager 220 determines that the user is in a public theatre and assumes a relatively high-priority appointment. The alert manager 220 withholds the generation of the alert or causes the message delivery device 190 to generate the alert as appropriate.

In a twelfth example, an inbound message taking the form of a telephone call is received. The alert manager 220 determines that the user should not be alerted. However, instead of simply foregoing the alert, the alert manager 220 causes a predetermined outbound message to be originated responding to the inbound message. Thus, the party making the call may hear a response indicating that the user will call him back within a certain period of time. The alert manager 220 may further create a reminder on the user's calendar to return the call.

In a thirteenth example, the user wishes to originate an outbound message taking the form of a telephone call during a particular weekday time. The delivery device interface 240 determines that the user typically calls one of seven parties during that time. Accordingly, the delivery device interface 240 interacts with the contacts database 250 to retrieve the names and telephone numbers of the seven parties, arranges them into a list and causes the message delivery device 190 to display the list on the display 260, thereby to allow the user to choose the party he wishes to call from a relatively short list.

FIG. 3 is a flow diagram of one embodiment of a method of handling message delivery. The method begins in a start step 310. In a step 320, an inbound message is received from a source via a communication network. In a step 330, a user's calendar data is retrieved. In a step 340, the priority of the inbound message is determined. In one embodiment, the priority of the inbound message is determined based upon one or more of: a name of a party associated with the inbound message, contact information of a party associated with the inbound message, a frequency of messages originated by a party associated with the inbound message, the type of the inbound message and the source of the inbound message. In another embodiment, the user's contact data is employed to determine a priority of the inbound message. In yet another embodiment, priority data received with the inbound message is employed to determine a priority of the inbound message.

In a step 350, a determination is made as to whether a message delivery device associated with the user should generate an alert to the user regarding the receipt. In a step 350, the alert is queued for delivery to the message delivery device based on the determination. In one embodiment, the alert takes the form of at least a portion of the inbound message itself.

In another embodiment, the alert takes the form of a command to the message delivery device to turn on a lamp, a vibrator, a speaker or the like.

Various of the embodiments handle outbound messages as well. In such embodiments, the method includes a step 370 in which at least some contact data of the user is arranged for presentation to the user based upon at least a time the user is initiating an outbound message The method ends in an end step 370. As stated above, the method may be carried out in the message delivery device itself or in a computer associated with the communication network. The method may alternatively be carried out in other computing environments as may be appropriate for a particular application.

Those skilled in the art to which this application relates will appreciate that other and further additions, deletions, substitutions and modifications may be made to the described embodiments.

What is claimed is:

1. A message handler, comprising:
a network interface operable to detect a receipt of an inbound message via a communication network; and
an alert manager associated with said network interface and operable to employ calendar data of a user to make a determination of whether a message delivery device associated with said user should generate an alert to said user regarding said receipt.

2. The message handler as recited in claim 1 wherein said alert manager is further operable to communicate with a contacts database of said user and employ contact data retrieved therefrom to determine a priority of said inbound message, said calendar data including data selected from the group consisting of:
an existence of an appointment of said user,
a priority of an appointment of said user, and
at least one contact rule associated with an appointment of said user.

3. The message handler as recited in claim 1 wherein said alert manager is operable to determine a priority of said inbound message based upon at least one of:
priority data received with said inbound message,
a name of a party associated with said inbound message,
contact information of a party associated with said inbound message,
a frequency of messages received from a party associated with said inbound message,
a frequency of messages sent by said user to a party associated with said inbound message,
a type of said inbound message, and
a source of said inbound message.

4. The message handler as recited in claim 1 further comprising a delivery device interface associated with said alert manager and operable to queue said alert for transmission to said inbound message delivery device, said alert selected from the group consisting of:
at least a portion of said inbound message, and
a command to said inbound message delivery device.

5. The message handler as recited in claim 1 further comprising a delivery device interface associated with said alert manager and operable to create an arrangement of at least some contact data of said user for presentation thereto, said arrangement based upon at least a time said user is initiating an outbound message.

6. The message handler as recited in claim 1 wherein said inbound message is selected from the group consisting of:
an inbound telephone call,
an inbound text message,
an inbound communication from a social network,
an inbound email message, and
an inbound news item.

7. The message handler as recited in claim 1 wherein said alert manager is further operable to employ a location of said message delivery device to make said determination.

8. A method of handling message delivery, comprising:
receiving an inbound message from a source via a communication network;
retrieving calendar data of a user;
making a determination of whether a message delivery device associated with said user should generate an alert to said user regarding said receipt; and
queuing said alert for delivery to said inbound message delivery device based on said determination.

9. The method as recited in claim 8 further comprising employing contact data retrieved therefrom to determine a priority of said inbound message, said calendar data including data selected from the group consisting of:
an existence of an appointment of said user,
a priority of an appointment of said user, and
at least one contact rule associated with an appointment of said user.

10. The method as recited in claim 8 further comprising determining a priority of said inbound message based upon at least one of:
priority data received with said inbound message,
a name of a party associated with said inbound message,
contact information of a party associated with said inbound message,
a frequency of messages received from a party associated with said inbound message,
a frequency of messages sent by said user to a party associated with said inbound message,
a type of said inbound message, and
a source of said inbound message.

11. The method as recited in claim 8 wherein said alert is selected from the group consisting of:
at least a portion of said inbound message, and
a command to said inbound message delivery device.

12. The method as recited in claim 8 further comprising arranging at least some contact data of said user for presentation thereto based upon at least a time said user is initiating an outbound message.

13. The method as recited in claim 8 wherein said inbound message is selected from the group consisting of:
an inbound telephone call,
an inbound text message,
an inbound communication from a social network,
an inbound email message, and
an inbound news item.

14. The method as recited in claim 8 wherein said alert manager is further operable to employ a location of said message delivery device to make said determination.

15. A message delivery device, comprising:
a display operable to provide an alert;
a processor coupled to said display and operable to execute software instructions; and
a memory coupled to said processor and operable to store a calendar database and software instructions operable to employ calendar data from said calendar database to make a determination of whether said inbound message delivery device should generate an alert regarding a receipt of an inbound message via a communication network.

16. The message delivery device as recited in claim 15 wherein said memory is further operable to store a contacts database, said software instructions further operable to communicate with said contacts database and employ contact data retrieved therefrom to determine a priority of said inbound message, said calendar data including data selected from the group consisting of:
an existence of an appointment of said user,
a priority of an appointment of said user, and
at least one contact rule associated with an appointment of said user.

17. The message delivery device as recited in claim 15 wherein said software instructions are further operable to determine a priority of said inbound message based upon at least one of:
priority data received with said inbound message,
a name of a party associated with said inbound message,
contact information of a party associated with said inbound message,
a frequency of messages received from a party associated with said inbound message,
a frequency of messages sent by said user to a party associated with said inbound message,
a type of said inbound message, and
a source of said inbound message.

18. The message delivery device as recited in claim 15 wherein said software instructions are operable to create an arrangement of at least some contact data of said user for presentation thereto, said arrangement based upon at least a time said user is initiating an outbound message.

19. The message delivery device as recited in claim 15 wherein said inbound message is selected from the group consisting of:
an inbound telephone call,
an inbound text message,
an inbound communication from a social network,
an inbound email message, and
an inbound news item.

20. The message delivery device as recited in claim 15 wherein said software instructions are further operable to employ a location of said message delivery device to make said determination.
